(19) United States
(12) Patent Application Publication
(10) Pub. No.: US 2020/0303727 A1
(43) Pub. Date: Sep. 24, 2020

(54) ALKALINE ELECTROCHEMICAL CELLS

(71) Applicant: Energizer Brands, LLC, St. Louis, MO (US)

(72) Inventors: M. Edgar Armacanqui, Madison, WI (US); Andrew J. Roszkowski, Waunakee, WI (US); Donald Raymond Crowe, Dodgeville, WI (US)

(21) Appl. No.: 16/765,613

(22) PCT Filed: Nov. 19, 2018
(86) PCT No.: PCT/US2018/061831

§ 371 Date: May 20, 2020

Related U.S. Application Data
(60) Provisional application No. 62/588,550, filed on Nov. 20, 2017.

(51) Int. Cl. H01M 4/24; H01M 2/16; H01M 4/42; H01M 10/26

(52) U.S. Cl. CPC H01M 4/244; H01M 2/1673; H01M 2004/023; H01M 10/26; H01M 4/42

(57) ABSTRACT

An alkaline electrochemical cell includes a cathode; a gelled anode; and a separator disposed between the cathode and the anode; wherein the gelled anode includes, an anode active material, an alkaline electrolyte; a gelling agent; and about 10 ppm to 250 ppm of an alkoxylated alkyl phosphate ester surfactant; and wherein from about 15% to about 60% by weight of the anode active material relative to a total amount of anode active material has a particle size of less than about 75 μm

### CROSS-REFERENCE TO RELATED APPLICATIONS

This application claims the benefit of and priority to U.S. Provisional Appl. No. 62/588,550, filed Nov. 20, 2017, the entirety of which is hereby incorporated by reference for any and all purposes.

### FIELD

The present technology is generally related to the field of electrochemical cells. In particular, the technology is related to alkaline cells with improved performance and reliability.

### BACKGROUND

Alkaline electrochemical cells are used to power a wide variety of devices used in everyday life. For example, devices such as radios, toys, cameras, flashlights, and hearing aids all ordinarily rely on one or more electrochemical cells to operate. These cells produce electricity by electrochemically coupling, within the cell, a reactive metallic anode to a cathode through a suitable alkaline electrolyte.

Reliability and high rate discharge performance of alkaline cells is partly dependent on using the right anode formulation to minimize the oxidation of the zinc anode when the battery is at rest, particularly after partial discharge. This may be accomplished by proper selection of the anode active material, e.g. a zinc alloy, and by maximizing the purity of the material. Metallic impurities present in the zinc alloy may cause generation of hydrogen gas within the cell leading to pressure increases during intermittent use or storage in the undischarged or partially discharge condition. Additional sources of such metallic impurities may originate from other raw battery components such as the electrolyte, the electrolytic manganese dioxide, the graphite, the battery casing, as well as from the anode current collector. Impurities in the zinc and from other sources may solubilize in the electrolyte, diffuse by convection to the anode compartment, and then precipitate on the anode surface to serve as cathode sites during electrochemical corrosion reactions, thus leading to enhanced gas generation. To minimize harmful impurity effects, battery electrochemical cells usually contain corrosion inhibitors or surfactant materials. The role of an anode inhibitor is to form a protective film on the surface of the anode to inhibit access of undesirable reactants to the anode surface, while the battery is at rest, effectively minimizing reduction reactions which form hydrogen gas. In the absence of a good inhibitor, the gas pressure build up during battery storage can result in cell venting, and eventually lead to leakage and failure of the cell. Thus, it is desirable to find means to effectively suppress gas generation inside battery cells that can suppress failures due to leakage, while improving battery life storage and battery performance.

### SUMMARY

In one aspect, an alkaline electrochemical cell is provided, the cell including a cathode, a gelled anode, and a separator disposed between the cathode and the anode, wherein the gelled anode includes, an anode active material, an alkaline electrolyte, a gelling agent, and about 10 ppm to 250 ppm of an alkoxylated alkyl phosphate ester surfactant, and wherein the anode active material has an apparent density from about 2.60 g/cc to about 3.35 g/cc, about 15% to about 60% by weight of the anode active material relative to a total amount of anode active material has a particle size of less than about 75 μm, and about 5% to about 25% by weight of the anode active material relative to the total amount of the anode active material has a particle size of greater than about 150 μm.

In one aspect, a gelled anode is provided, including an anode active material, an alkaline electrolyte, a gelling agent, and about 10 ppm to 250 ppm of an alkoxylated alkyl phosphate ester surfactant, wherein the anode active material has an apparent density from about 2.60 g/cc to about 3.35 g/cc, about 15% to about 60% by weight of the anode active material relative to a total amount of anode active material has a particle size of less than about 75 μm, and about 5% to about 25% by weight of the anode active material relative to the total amount of the anode active material has a particle size of greater than about 150 μm.

In some embodiments that are combinable with the above aspects and embodiments, the alkoxylated alkyl phosphate ester surfactant includes polyoxyethylene tridecyl ether phosphate (i.e., trideceth-6-phosphate). In some embodiments that are combinable with the above aspects and embodiments, the electrolyte in the gelled anode has a hydroxide concentration of about 24 wt % to about 36% wt %. In some embodiments that are combinable with the above aspects and embodiments, the gelled anode includes about 0.2 wt % to about 1.0 wt % of a gelling agent.

In some embodiments that are combinable with the above aspects and embodiments, the gelling agent includes a crosslinked polyacrylic acid. In some embodiments, the anode active material includes a zinc alloy. In some embodiments that are combinable with the above aspects and embodiments, the zinc alloy includes zinc, indium, and/or bismuth. In other embodiments, the zinc alloy includes about 100 ppm to about 300 ppm of bismuth, and about 100 ppm to about 300 ppm of indium. In some embodiments that are combinable with the above aspects and embodiments, the anode includes from about 62% to about 72% by weight of the zinc alloy, relative to the total weight of the anode. In some embodiments that are combinable with the above aspects and embodiments, the electrochemical cell is an LR14 or an LR20 cell.

In some embodiments that are combinable with the above aspects and embodiments, about 15% to about 65% by weight of the anode active material, relative to the total amount of anode active material has a particle size of less than about 75 microns, about 5% to about 25% by weight relative of the total zinc alloy has a particle size of greater than about 150 micrometers, and less than 10% by weight of the anode active material, relative to the total amount of anode active material has a particle size of less than about 45 microns.

In one aspect, a gelled anode is provided, wherein the gel includes an anode active material, an alkaline electrolyte comprising about 26% to about 34% by weight of potassium hydroxide, about 0.2% to about 1.0%, by weight of a gelling agent, and about 10 ppm to 250 ppm of polyoxyethylene tridecyl ether phosphate, wherein the anode active material has an apparent density from about 2.60 g/cc to about 3.35 g/cc, about 15% to about 60% by weight of the anode active material relative to a total amount of anode active material has a particle size of less than about 75 and about 5% to about 25% by weight of the anode active material relative to the total amount of the anode active material has a particle size of greater than about 150 μm.

### BRIEF DESCRIPTION OF THE DRAWINGS

FIG. 1 is a graph illustrating gassing characteristics of undischarged (UD) LR20 cells that include gelled anodes according to Example 1.

FIG. 2 is a graph illustrating gassing characteristics of partially discharged (PD) LR20 cells including gelled anodes according to Example 2.

FIG. 3 is a graph of discharge performance at 2.2Ω for one hour per day of the LR20 cells according to Example 3.

FIG. 4 is a graph of discharge performance at 600 mA for two hours per day of the LR20 cells including gelled anodes according to Example 3.

FIG. 5 shows the amperage after drop test for LR20 cells including gelled anodes according to Example 4.

FIG. 6 is a graph of the discharge performance of LR20 cells in toy test after storage at room temperature for three months according to Example 4.

FIG. 7 is a graph illustrating gassing characteristics of partially discharged (PD) for LR20 cells including gelled anodes according to Example 4.

FIG. 8 is a graph illustrating gassing characteristics of undischarged (UD) LR20 cells, including gelled anodes according to Example 5, after storage for one week at about 71° C.

FIG. 9 is a graph illustrating gassing characteristics of partially discharged (PD) LR20 cells, including gelled anodes according to Example 5, after storage for one week at about 71° C.

FIG. 10 is a graph illustrating gassing characteristics of undischarged (UD) LR20 cells, including gelled anodes according to Example 5, after storage for two days at 85° C.

FIG. 11 is a graph illustrating the discharge performance of LR20 cells in heavy industrial flashlight test (HIFT) and portable stereo test, after storage at room temperature for 1 month.

FIG. 12 is a graph of the ANSI discharge performance of LR20 cells including gelled anodes with zinc powders having zinc apparent densities of 2.77 g/cc and 3.0 g/cc.

FIG. 13 is a graph of the cell gas generated after partial discharge of LR20 cells after storage at 160° C. for 1 week.

FIG. 14 is a graph of the ANSI discharge performance of LR20 cells including gelled anodes with HF zinc at 63% loading having apparent density of 2.77 g/cc.

FIG. 15 is a graph illustrating the discharge performance of LR14 cells in portable stereo, portable lighting, and toy test, after storage at room temperature for 3 months.

FIG. 16 is a graph illustrating gassing characteristics of undischarged (UD) LR14 cells that include gelled anodes.

FIG. 17 is a graph illustrating gassing characteristics of partially discharged (PD) LR14 cells that include gelled anodes.

It is to be further noted that the design or configuration of the components presented in these figures are not scale, and/or are intended for purposes of illustration only. Accordingly, the design or configuration of the components may be other than herein described without departing from the intended scope of the present disclosure. These figures should therefore not be viewed in a limiting sense.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and may be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, 5 to 40 mole % should be interpreted to include not only the explicitly recited limits of 5 to 40 mole %, but also to include sub-ranges, such as 10 mole % to 30 mole %, 7 mole % to 25 mole %, and so forth, as well as individual amounts, including fractional amounts, within the specified ranges, such as 15.5 mole %, 29.1 mole %, and 12.9 mole %, for example.

As used herein, the term “zinc anode” refers to an anode that includes zinc as an anode active material.

As used herein, “fines” are particles passing through a standard 200 mesh screen in a normal sieving operation (i.e., with the sieve shaken by hand). “Dust” consists of particles passing through a standard 325 mesh screen in a normal sieving operation. “Coarse” consists of particles not passing through a standard 100 mesh screen in a normal sieving operation. Mesh sizes and corresponding particle sizes as described here apply to a standard test method for sieve analysis of metal powders which is described in ASTM B214. Typically, fines comprise particles smaller than 75 microns, coarse comprises particles greater than 150 microns, and dust comprises particles smaller than 45 microns.

As used herein, “aspect ratio” refers to the dimension determined by the ratio between the length of the longest dimension of the particle and the relative width of the particle.

As used herein, the term “ppm” means parts per million by weight, unless explicitly expressed otherwise.

The present disclosure is directed to improving the discharge rate capability of cells, such as alkaline cells. The disclosure is also aimed at improving the anode discharge efficiency of cells by the proper combination of the anode active material loading, type of anode active material, type of inhibitor, inhibitor concentration, electrolyte concentration, and anode active particle size distribution, among other factors. It has now, surprisingly, been found by the present disclosure that, the performance and reliability of alkaline cells, such as LR20 and LR14 cells, may be significantly improved by developing an anode formulation using proper selection of zinc particle size distribution, inhibitor, and electrolyte concentration, among other factors.

In one aspect, the present disclosure is directed to an electrochemical cell which includes a cathode, a gelled anode, and a separator disposed between the cathode and the anode. Suitable electrochemical cell structures may include, for example, alkaline cells, alkaline cylindrical cells, e.g., metal-metal oxide cell, as well as galvanic cells, such as in metal-air cells, e.g., zinc-air cell. Among the cylindrical metal-metal oxide cells and metal-air cells, the anode material is applicable to those shaped for AA, AAA, AAAA, C, or D cells. These include, for example, alkaline cells LR03, LR06, LR8D425, LR14, LR20. The electrochemical cells have applications to non-cylindrical cells, such as flat cells (e.g., prismatic cells and button cells) and rounded flat cells (e.g., having a racetrack cross-section). Metal-air cells which include the anode described herein may usefully be constructed as button cells for the various applications such as hearing aid batteries, and in watches, clocks, timers, calculators, laser pointers, toys, and other novelties. Suitable electrochemical cells may also include any metal air cell using flat, bent, or cylindrical electrodes. Use of the anode as a component in other forms of electrochemical cells is also contemplated.

The anode for the electrochemical cell is as described hereinabove. Accordingly, in one aspect, provided is an alkaline electrochemical cell which includes a cathode, an anode which includes an anode active material, and a separator disposed between the cathode and the anode. In some embodiments of the electrochemical cell, about 15% to about 60% by weight of the anode active material relative to a total amount of anode active material has a particle size of less than about 75 μm. In various embodiments, the anode of the electrochemical cell is a gelled anode. In various embodiments of the electrochemical cell, the gelled anode includes an anode active material, wherein from about 15% to about 60%, by weight relative to a total weight of anode active material has a particle size of less than about 75 μm. The gelled anode further includes an alkaline electrolyte comprising a hydroxide material, a gelling agent, and about 10 ppm to 250 ppm of an alkoxylated alkyl phosphate ester surfactant.

The cathode of the electrochemical cell may include any cathode active material generally recognized in the art for use in alkaline electrochemical cells. The cathode active material may be amorphous or crystalline, or a mixture of amorphous and crystalline. For example, the cathode active material may include, or be selected from, an oxide of copper, an oxide of manganese as electrolytic, chemical, or natural type (e.g., EMD, CMD, NMD, or a mixture of any two or more thereof), an oxide of silver, and/or an oxide or hydroxide of nickel, as well as a mixture of two or more of these oxides or hydroxide. Suitable examples of positive electrode materials include, but are not limited to, MnO₂ (EMD, CMD, NMD, and mixtures thereof), NiO, NiOOH, Cu(OH)₂, cobalt oxide, PbO₂, AgO, Ag₂O, Ag₂Cu₂O₃, CuAgO₂, CuMnO₂, Cu Mn₂O₄, Cu₂MnO₄, Cu₃₋ₓMnₓO₃, Cu₁₋ₓMnₓO₂, Cu₂₋ₓMnₓO₂ (where x<2), Cu₃₋ₓMnₓO₄ (where x<3), Cu₂Ag₂O₄, or a combination of any two or more thereof.

The electrochemical cell may include a separator between the cathode and the zinc anode, which is designed for preventing short-circuiting between the two electrodes. Generally, any separator material and/or configuration suitable for use in an alkaline electrochemical cell, and with the cathode and/or anode materials set forth herein above, may be used in accordance with the present disclosure. In one embodiment, the separator is a non-conductive separator. In one embodiment, the electrochemical cell includes a sealed separator system that is disposed between a gelled anode of the type described here and a cathode. The separator may be made of any alkaline resistant natural, woven or non-woven porous material, including, but not limited to, polymer materials, Tencel® (lyocell), mercerized wood pulp, polypropylene, polyethylene, cellophane, cellulose, methylcellulose, rayon, nylon and combinations thereof. In some embodiments, the separator is composed of a porous material which includes a paper composed of one or more polymeric fibers. In some embodiments, the separator a porous material which includes one or more polymer fibers with an effective amount of a surface active agent embedded therein. Suitable polymer materials for the polymeric fiber include, but are not limited to, polyvinyl alcohol, polyamides, polyethylene terephthalate, polypropylene terephthalate, polybutylene terephthalate, polyvinylidene fluoride, polyacrylonitrile, polypropylene, polyethylene, polyurethane and blends, mixtures and copolymers thereof such as rayon, nylon, and the like and combinations thereof.

An exemplary embodiment of an alkaline electrochemical cell is described in PCT Publication No. WO 2016/183373, the complete disclosure of which is incorporated herein by reference.

In one aspect, a gelled anode is provided that include an anode active material, wherein from about 15% to about 60%, by weight relative to a total weight of anode active material has a particle size of less than about 75 μm, an alkaline electrolyte having about 24% to about 36% by weight of potassium hydroxide, about 0.2% to about 1.0%, by weight of a gelling agent, and about 10 ppm to 250 ppm of an alkoxylated alkyl phosphate ester surfactant.

In various embodiments, the anode active material may include zinc, which may be used alone or in combination with one or more other metals. The anode active material may be in the form of an alloy. Thus, in some embodiments the anode active material may include a zinc alloy. In some embodiments, the type of the anode active material may be similar that described in substantial detail in U.S. Patent Publication No. 2015/0037627.

Suitable alloy materials may include from about 0.01% to about 0.5% by weight of alloy agent alone, or in combination with, from about 0.005% to about 0.2% by weight of a second alloying agent such as bismuth, indium, lithium, calcium, aluminum, and the like. For example, in one or more embodiments a suitable powder including zinc may also include, or be alloyed with, one or more metals such as indium, bismuth, calcium, aluminum, lead, and the like. Accordingly, in this regard it is to be noted that, as used herein, “anode active material” and/or “zinc” may refer to a particle or powder alone, or one that has been optionally mixed or alloyed with one or more other metals. Anode active material particles may be present in a variety of forms including, for example, elongated, round, as well as fiber-like or flake-like particles.

In some embodiments, the zinc alloy includes indium and bismuth. In some embodiments, the zinc alloy includes zinc, bismuth, and indium. In some embodiments, the zinc alloy includes zinc, bismuth, indium, and aluminum. The concentrations of the metals alloyed with zinc may range from about 20 ppm to about 750 ppm. In some embodiments, the alloying metals are present at a concentration of about 50 ppm to 550 ppm. In other embodiments, the alloying metals are present at a concentration of about 130 ppm to 270 ppm. In other embodiments, the alloying metals are present at a concentration of about 150 ppm to 250 ppm. In some embodiments, the zinc alloy includes bismuth and indium as main alloying elements, each at a concentration of about 100 ppm to about 300 ppm. In some embodiments, the zinc alloy includes bismuth and indium as main alloying elements, each at a concentration of about 200 ppm.

The anode active material may be present in the anode in the form of coarse, fine, or dust particles, for example, or any combination of these forms. Anode active materials, such as zinc alloy particles (STD) that are conventionally used in electrochemical cells, typically have a particle size distribution of about 0.5% to about 2.0% dust, about 5% to about 25% fines and about 25% to about 60% coarse particles. In the present application, the anode includes high fines (HF) anode active materials, where the fines content is higher and coarse content is lower than that of conventional standard zinc powders. In various embodiments, the anode active material has a particle size distribution of less than about 15 wt % dust, about 10 wt % to about 70 wt % fines and about 5 wt % to about 35 wt % coarse particles. In other embodiments, the anode active material of the present technology has a particle size distribution of less than about 10 wt % dust, about 15 wt % to about 65 wt % fines and about 5 wt % to about 25 wt % coarse particles.

The anode active material may have an average particle size of about 70 micrometers to about 175 micrometers. This includes an average particle size of about 75 micrometers, about 80 micrometers, about 85 micrometers, about 90 micrometers, about 100 micrometers, about 110 micrometers, about 120 micrometers, about 130 micrometers, about 140 micrometers, or about 150 micrometers. In some embodiments, the anode active material has an average particle size of about 100 micrometers to about 170 micrometers. In some embodiments, the anode active material includes zinc alloy particles having an average particle size of about 120 micrometers. Particle size distribution d50 is the particle diameter at 50% in the cumulative distribution. In this disclosure, the anode material includes zinc active materials with a d50 from about 60 micrometers to about 120 micrometers. This includes d50 values of 80 micrometers, about 85 micrometers, about 90 micrometers, about 95 micrometers, about 100 micrometers, about 105 micrometers, and about 110 microns

In some embodiments, greater than 15% by weight of the anode active material, relative to the total amount of anode active material present in the gelled anode, has a particle size of less than about 75 micrometers. This includes where greater than about 20%, greater than about 25%, greater than about 30% or greater than about 35% by weight of the anode active material, relative to the total amount of anode active material present in the gelled anode, has a particle size of less than about 75 micrometers. In some embodiments, about 15% to about 60% by weight of the anode active material, relative to the total amount of anode active material present in the gelled anode, has a particle size of less than about 75 micrometers. This includes embodiments wherein about 15% to about 60%, about 20% to about 50%, about 25% to about 45%, or about 35% to about 40%, and ranges between any two of these values or less than any of these values, by weight of the anode active material, relative to the total amount of anode active material present in the gelled anode, has a particle size of less than about 75 micrometers. In some embodiments, about 30% by weight of the anode active material, relative to the total amount of anode active material present in the gelled anode, has a particle size of less than about 75 micrometers. In some embodiments, about 40% by weight of the anode active material, relative to the total amount of anode active material present in the gelled anode, has a particle size of less than about 75 micrometers. In some embodiments, about 15% to about 60% by weight of the anode active material, relative to the total amount of anode active material present in the gelled anode, has a particle size of less than about 75 micrometers. In some embodiments, about 20% to about 50% by weight of the anode active material, relative to the total amount of anode active material present in the gelled anode, has a particle size of less than about 75 micrometers.

In some embodiments less than about 35% by weight of the anode active material relative to the total amount of anode active material present in the gelled anode has a particle size of greater than about 150 micrometers. This includes embodiments wherein less than about 30%, less than about 25%, less than about 20% or less than about 15% by weight of the anode active material, relative to the total amount of anode active material present in the gelled anode, has a particle size of greater than about 150 micrometers. In some embodiments less than about 20% by weight of the anode active material relative to the total amount of anode active material present in the gelled anode has a particle size of greater than about 150 micrometers. In some embodiments, about 1% to about 40% by weight of the anode active material, relative to the total amount of anode active material present in the gelled anode, has a particle size of greater than about 150 micrometers. This includes embodiments wherein about 2% to about 30%, about 5% to about 25%, about 10% to about 20%, or about 12% to about 18%, and ranges between any two of these values or less than any of these values, by weight of the anode active material, relative to the total amount of anode active material present in the gelled anode, has a particle size of greater than about 150 micrometers.

In some embodiments less than about 20% by weight of the anode active material relative to the total amount of anode active material present in the gelled anode has a particle size of less than about 45 micrometers. This includes embodiments wherein less than about 15%, less than about 12%, less than about 10% or less than about 5% by weight of the anode active material, relative to the total amount of anode active material present in the gelled anode, has a particle size of less than about 45 micrometers. In some embodiments, about 1% to about 20% by weight of the anode active material relative to the total amount of anode active material present in the gelled anode, has a particle size of less than about 45 micrometers. This includes embodiments wherein about 1% to about 20%, about 2% to about 15%, or about 5% to about 10%, and ranges between any two of these values or less than any of these values, by weight of the anode active material, relative to the total amount of anode active material present in the gelled anode, has a particle size of less than about 45 micrometers. In some embodiments, about 2% to about 10% by weight of the anode active material relative to the total amount of anode active material present in the gelled anode, has a particle size of less than about 45 micrometers.

A suitable zinc particle size distribution may be one in which about 15% to about 65% by weight of the anode active material, relative to the total amount of anode active material has a particle size of less than about 75 microns, about 5% to about 25% by weight relative of the total zinc alloy has a particle size of greater than about 150 micrometers, and less than 10% by weight of the anode active material, relative to the total amount of anode active material has a particle size of less than about 45 microns.

The gelled anode may include a zinc loading lower than the loading in conventional cells. For example, the gelled anode may have a zinc loading of about 75 wt % or less, relative to the weight of the gelled anode. In some embodiments, the gelled anode may have a zinc loading of about 72 wt % or less, about 68 wt % or less, about 65 wt % or less, about 64 wt % or less, or about 63 wt % or less, relative to the weight of the gelled anode. In some embodiments, the gelled anode may have a zinc loading of about 60 wt % to about 75 wt %, relative to the weight of the gelled anode. This includes zinc loading of about 60 wt % to about 75 wt %, about 62 wt % to about 72 wt %, about 65 wt % to about 70 wt %, about 66 wt % to about 69 wt %, or about 67 wt % to about 68 wt %, and ranges between any two of these values or less than any of these values, by weight of the anode active material, relative to the weight of the gelled anode. In some embodiments, the gelled anode may have a zinc loading of about 64 wt %, relative to the weight of the gelled anode. In other embodiments, the gelled anode may have a zinc loading of about 63 wt %, relative to the weight of the gelled anode.

Surface morphology of zinc alloy can influence gas generation, which can also be impacted by the zinc alloy apparent density. It has been found that cell gassing tends to decrease with increasing apparent density. Apparent density also impacts discharge performance. Medium rates of discharge drains, such as Hift and Toy tests in LR20 cells can enhance with increasing apparent density. Increasing the apparent density can result in spheroidal type particles with aspect ratios greater than 0.6, particularly with fine particles smaller than about 75 micros. Spherical type particles are expected to have relatively low surface discontinuities, preferred reaction sites for gas generation, thus leading to less hydrogen gas formation. Additionally, the packing density as well as particle-to particle contact of the zinc powder can improve, resulting in enhanced discharge performance, particularly at intermediate rates of discharge of LR14 and LR20 cells.

In some embodiments of the present disclosure, the anode active material has an apparent density below about 5.00 g/cubic centimeters (“cc”). In other embodiments, the anode active material has an apparent density of from about 2.00 g/cc to about 4.15 g/cc, in some embodiments from about 2.25 g/cc to about 3.85 g/cc, in some embodiments about 2.50 g/cc to about 3.50 g/cc, in some embodiments about 2.60 g/cc to about 3.35 g/cc, and in some embodiments about 2.70 g/cc to about 3.15 g/cc. In yet other embodiments, the anode active material has an apparent density of about 2.70 g/cc, in some embodiments about 3.15 g/cc, and in some embodiments about 3.35 g/cc. In still other embodiments, the anode active material has an average apparent density of about 2.70 g/cc, in other embodiments an average apparent density of about 2.95 g/cc, and in yet other embodiments an average apparent density of about 3.15 g/cc. In some embodiments, the anode active material has an average apparent density of from about 2.80 g/cc to about 3.15 g/cc.

The gelled anode may include an alkaline electrolyte, and in some embodiments an alkaline electrolyte having a relatively low hydroxide content. Suitable alkaline electrolytes include, for example, aqueous solutions of potassium hydroxide, sodium hydroxide, lithium hydroxide, as well as combinations of any two or more thereof. In one particular embodiment, however, a potassium hydroxide-containing electrolyte is used. In other embodiments, the alkaline electrolyte includes water and potassium hydroxide.

The electrolytes advantageously have a lower concentration of hydroxide ions in the electrolyte than those used in conventional cells. For example, the electrolyte may have a hydroxide (e.g., potassium hydroxide) concentration of less than about 36%, based on the total electrolyte weight. This includes a hydroxide concentration of less than about 35%, less than about 34%, less than about 32%, less than about 30%, less than about 29%, or less than about 28%, based on the total electrolyte weight. In various embodiments, the electrolyte has a hydroxide concentration of about 24% to about 36%, about 26% to about 34%, about 27% to about 34%, about 28% to about 34%, or about 28% to about 32%, and ranges between any two of these values or less than any one of these values. This includes a hydroxide concentration of about 35%, about 34%, about 32%, about 31%, about 30.5%, about 30%, about 29%, or about 28%, based on the total electrolyte weight. In an illustrative embodiment (e.g., a gelled anode suitable for use in a cell sized and shaped as, for example, an LR14 or LR 20 alkaline cell), the hydroxide concentration of the electrolyte is about 30% to about 32% by weight, based on the total weight of the electrolyte.

In some embodiments, the hydroxide electrolyte content in the gelled anode is for example at least about 24% by weight, at least about 26% by weight, or at least about 28% by weight, and less than about 34% by weight, less than about 32% by weight, or less than about 30% by weight, based on the total weight of the gelled anode. The concentration of the electrolyte in gelled anode of the present disclosure may, therefore, typically be within the range of from about 26% by weight to about 34% by weight, from about 28% by weight to about 32% by weight, or from about 30% by weight to about 32% by weight, based on the total weight of the gelled anode.

The gelled anode may further include a gelling agent. The gelling agent is present in the anode, at least in part, to add mechanical structure and/or to coat the metallic particles to improve ionic conductivity within the anode during discharge. Suitable gelling agents are those that impart a rigid-type gel structure and a slightly decreased packing density to the gelled anode within the cell, as well as a corresponding greater but more stable anode particle-to-particle distance. In this regard it is to be noted that, as used herein, “gelled anode” (as well as variations thereof) generally refers to the anode once the electrolyte (or in some instances the remaining portion of the electrolyte) has been added or introduced thereto. In contrast, a “coated metal anode” (as well as variations thereof) generally refers to the anode prior to addition or introduction of the electrolyte thereto (or the full amount of the electrolyte thereto).

The anode may be prepared by formulating an electrolyte, preparing a coated metal anode which includes the gelling agent, and then combining the electrolyte and the coated metal anode to form a gelled anode. The gelling agent of the present disclosure may include, for example, a highly cross-linked, polymeric chemical compound that has negatively charged acid groups, such as a polyacrylic acid gelling agent having a high degree of crosslinking.). Highly crosslinked polyacrylic acid gelling agents, are commercially available under the names Carbopol® (Carbopol® 940, Carbopol® 934, or Carbopol® 674) from Lubrizol Corporation (Wickliffe, Ohio), Flogel® (e.g., Flogel® 700 or Flogel® 800) from SNF Holding Company (Riceboro, Ga.), and Polygel® (e.g., Polygel® CK, or Polygel® CA, or Polygel CS) from 3V Sigma S.P.A. (Georgetown, S.C.), among others, are suitable for use in accordance with the present disclosure.

Suitable gelling agents may be selected based on various characteristics such as the degree of crosslinking, the viscosity, and/or density. The concentration of the gelling agent in the gelled anode may be optimized for a given use. For example, the concentration of the gelling agent is at least about 0.20 wt %, based on the total weight of the gelled anode, including at least about 0.30 wt %, at least about 0.40 wt %, at least about 0.50 wt %, at least about 0.60 wt %, at least about 0.65 wt %, at least about 0.675 wt %, at least about 0.70 wt % or more. For example, in various embodiments the concentration of the gelling agent in the gelled anode may be from about 0.20 wt % to about 1.5 wt %, about 0.40 wt % to about 1.00 wt %, about 0.60 wt % to about 0.70 wt %, or about 0.625 wt % to about 0.675 wt %, relative to the total weight of the gelled anode. In some embodiments, the gelled anode may include from about 0.40% to about 1.0% by weight of one or more gelling agent.

The gelled anode materials have a suitable viscosity required for good processing and cell discharge performance. For example, the gelled anode may exhibit an initial viscosity (i.e., a viscosity measured immediately after preparation, e.g., within less than 60 minutes (min) of its preparation) of from about 30,000 centipoise (cps) to about 300,000 cps, at about 21° C. In various embodiments, before and/or after incorporation into an electrochemical cell, the gelled anode of the present disclosure may exhibit a viscosity of at least about 25,000 cps, at least about 40,000 cps, at least about 55,000 cps, at least about 70,000 cps, at least about 85,000 cps, at least about 100,000 cps, at least about 130,000 cps, or more. In some embodiments, the gelled anode of the present disclosure exhibits a viscosity of from about 25,000 cps to about 250,000 cps, from about 40,000 cps to about 180,000 cps, from about 60,000 cps to about 150,000 cps, from about 80,000 cps to about 130,000 cps, or from about 100,000 cps to about 120,000 cps. The viscosities and densities of the gelled anode reported herein may be determined using conventional means known in the art. To measure anode gel viscosities and anode yield stress, a Brookfield DV-E Viscometer is used with a toggle speed at 0.5 rpm allowing two minutes rest before recording the viscosity reading. To determine the yield stress, a toggle speed of 1 rpm is selected to take the corresponding viscosity reading after two minutes. The yield strength is calculated by taking the difference between the readings observed with the toggle speed at 0.5 rpm and at 1 rpm divided by 100.

The technology provides an gelled anode having yield stress of greater than about 200 cps. This includes yield stress of from about 200 to about 2000, about 400 to about 1500, about 600 to about 1200, or about 800 to about 1000 cps, and ranges between any two of these values or less than any one of these values. In some embodiments, the gelled anode has a yield stress value of about 800 cps to about 1200 cps.

The gelled anode may include other components or additives such as, for example, absorbents, organic surfactants and inorganic corrosion-inhibitors. It is believed that the surfactants act at the anode-electrolyte interface by forming a hydrophobic film that protects the anode active surface during storage. The inhibitive efficiency of surfactants to increase the corrosion resistance of the anode active depends on their chemical structure, concentration, and their stability in the electrolyte. Thus, in some embodiments, the surfactants include corrosion or gassing inhibitors. Exemplary surfactants include organic phosphate esters such as alkyl and aryl phosphate esters with and without ethoxylation. Exemplary organic phosphate ester surfactants include ethylene oxide-adducts disclosed by Rossler et al. in U.S. Pat. No. 4,195,120, or surface-active heteropolar ethylene oxide additive including organic phosphate esters disclosed by Chalilpoyil et al. in U.S. Pat. No. 4,777,100, as well as commercially available surfactants such as Rhodafac® RM-510, Rhodafac® RS-610, Rhodafac® RA-600 (all from Solvay), Crodafos® T6A, Crodafos® SG-LQ (from Croda), Phospholan® PS-220, Phospholan® PS-131, Phospholan® CS-141 (all from Akzonobel), Witconate® 1840X, or Mafo® 13 MOD1 or a combination of any two or more thereof. In some embodiments, the organic phosphate ester surfactant includes a polyoxyethylene dinonylphenyl ether phosphate (e.g. available as Rhodafac® RM-510 E from Solvay). In other embodiments, the surfactant includes a polyoxyethylene tridecyl ether phosphate (i.e., trideceth-6 phosphate, e.g. available as Crodafos® T6A from Croda).

The concentration of the organic phosphate ester surfactant may range from about 0.0001 wt % to about 10 wt % relative to the weight of the anode. This includes from about 0.005 wt % to about 5 wt %, about 0.004 wt % to about 1 wt %, about 0.003 wt % to about 0.01 wt %, about 0.002 wt % to about 0.005 wt %, about 0.001 wt % to about 0.015 wt %, about 0.001 wt % to about 0.008 wt %, or about 0.01 wt % to about 0.1 wt % relative to the weight of the anode, and ranges between any two of these values or less than any one of these values. In some embodiments, the organic phosphate ester surfactant is present at a concentration from about 0.001 wt % to about 0.015 wt % relative to the total weight of the gelled anode mixture.

The organic phosphate ester surfactant may be present in the electrolyte from about 0.1 ppm to about 10000 ppm, based on the total weight of the electrolyte. In another embodiment, the organic phosphate ester surfactant is present in the electrolyte from about 1 ppm to about 5000 ppm. In another embodiment, the organic phosphate ester surfactant concentration in the electrolyte is about 5 ppm to about 1000. In one embodiment, the organic phosphate ester surfactant concentration in the electrolyte is about 10 ppm to about 250. In some embodiments, the organic phosphate ester surfactant concentration in the electrolyte is about 20 ppm to about 150 ppm. In some embodiments, the electrolyte includes from about 10 ppm to about 250 ppm of a polyoxyethylene dinonylphenyl ether phosphate (e.g. Rhodafac® RM-510 E). In other embodiments, the electrolyte includes from about 10 ppm to about 250 ppm of a polyoxyethylene tridecyl ether phosphate or trideceth-6 phosphate (e.g. Crodafos® T6A).

The gelled anode may include other components or additives, in addition to the anode active material, the gelling agent and the electrolyte. Such additives include, for example, absorbents, corrosion inhibitors or gassing inhibitor etc. Suitable absorbent materials may be selected from those generally known in the art. Exemplary absorbent materials include those sold under the trade name Salsorb™ or Alcasorb™ (e.g., Alcasorb™ CL15), which are commercially available from Ciba Specialty (Carol Stream, Ill.), or alternatively those sold under the trade name Sunfresh™ (e.g., Sunfresh DK200VB), commercially available from Sanyo Chemical Industries (Japan). When present, the concentration of absorbent in gelled anode of the present disclosure is less than about 0.5%, less than about 0.2%, less than about 0.15%, less than about 0.1%, less than about 0.075%, less than about 0.05%, less than about 0.025%, or even less than about 0.01%, of the total anode weight. In some embodiments, the gelled anode does not include additional additives such an alkali metal hydroxide, a metal oxide, or a metal. In some embodiments, the gelled anode does not include additives such as lithium hydroxide, cerium oxide, or tin.

In one aspect, provided is a gelled anode, and/or an electrochemical cell comprising such a gelled anode, which includes an anode active material, wherein from about 15% to about 60%, by weight relative to a total weight of anode active material has a particle size of less than about 75 μm, an alkaline electrolyte including about 24% to about 36% by weight of potassium hydroxide, about 0.2% to about 1.0%, by weight of a gelling agent, and about 10 ppm to 250 ppm of an organic phosphate ester surfactant. In some embodiments, the organic phosphate ester surfactant includes polyoxyethylene tridecyl ether phosphate (i.e., trideceth-6 phosphate, Crodafos® T6A).

In another aspect, provided is a gelled anode, and/or an electrochemical cell comprising such a gelled anode, which includes an anode active material, wherein from about 15% to about 60%, by weight relative to a total weight of anode active material has a particle size of less than about 75 μm, an alkaline electrolyte comprising about 24% to about 36% by weight of potassium hydroxide, about 0.2% to about 1.0%, by weight of a gelling agent, and about 10 ppm to 250 ppm of polyoxyethylene tridecyl ether phosphate (Crodafos® T6A). In another aspect, provided is a gelled anode, and/or an electrochemical cell comprising such a gelled anode, which includes an anode active material, wherein from about 20% to about 50%, by weight relative to a total weight of anode active material has a particle size of less than about 75 μm, an alkaline electrolyte comprising about 26% to about 34% by weight of potassium hydroxide, about 0.2% to about 1.0%, by weight of a gelling agent, and about 10 ppm to 250 ppm of polyoxyethylene tridecyl ether phosphate (Crodafos® T6A).

The gelled anodes and electrochemical cells of the present technology have several advantages over the conventional cells. The gelled anodes of the present technology are designed to improve resistance to drop failure at high fines content and a relatively low zinc loading (e.g., as low as 63 wt %). Further drop and discharge vibration failures in large cells is suppressed and cell gassing, such as after partial battery discharge, is reduced. The anode materials of the present technology also allow greater also particle-to-particle contact between the zinc particles which leads to improved reliability of the electrochemical cell.

It was surprisingly discovered that for electrochemical cells having container cans of larger diameter (e.g., LR14 cells), by utilizing the gelled anode of the present technology, the undischarged cell leakage may be significantly reduced or even essentially be eliminated, leading to an increase in reliability, which is contrary to expectations, and an unexpected outcome. Without wishing to be bound by theory, it is hypothesized that the reduction in leakage is a result of a combination of factors, including the use of HF zinc along with an optimized concentration of KOH, as well as the type of gellant. Further, contrary to expectations, performance of the electrochemical cells is also improved. Typically, the use of high fines containing zinc is known to suppress performance. However, in the present technology, the development of gelled anodes utilizing HF zinc combined with electrolytes having specific hydroxide concentration, and specific gellants was surprisingly observed to improve discharge performance of the electrochemical cell.

Accordingly, in one aspect, provided is a gelled anode, and/or an LR20 or LR14 electrochemical cell comprising such a gelled anode, which includes an anode active material, wherein from about 20% to about 55%, by weight relative to a total weight of anode active material has a particle size of less than about 75 μm and from about 5% to about 25%, by weight relative to a total weight of anode active material has a particle size of greater than about 150 μm, an alkaline electrolyte comprising about 26% to about 34% by weight of potassium hydroxide, about 0.3% to about 0.9%, by weight of a gelling agent, and about 20 ppm to 150 ppm of an organic phosphate ester surfactant.

As further detailed above, the electrochemical cells of the present disclosure have been observed to exhibit improved performance characteristics, which may be measured or tested in accordance with several methods under the American National Standards Institute (ANSI). Results of various tests of cells of the present disclosure are detailed below in the Examples.

In one aspect a method for improving the reliability of an electrochemical cell subject to gassing is provided, wherein the method includes providing as the active anode of said cell, a gelled anode which includes an anode active material, wherein from about 15% to about 60%, by weight relative to a total weight of anode active material has a particle size of less than about 75 μm, an alkaline electrolyte, and a gelling agent.

In another aspect a method for enhancing the discharge performance of an electrochemical cell is provided, wherein the method includes providing as the active anode of said cell, an gelled anode which includes an anode active material, wherein from about 15% to about 60%, by weight relative to a total weight of anode active material has a particle size of less than about 75 μm, an alkaline electrolyte, and a gelling agent.

In various embodiments of the method for improving the reliability and/or enhancing the discharge performance of an electrochemical cell, the anode for the electrochemical cell is as described hereinabove. Accordingly, in various embodiments of the methods, the anode of the electrochemical cell is a gelled anode. In various embodiments of the methods, the gelled anode includes an anode active material, wherein from about 15% to about 60%, by weight relative to a total weight of anode active material has a particle size of less than about 75 μm. The gelled anode further includes an alkaline electrolyte comprising a hydroxide material, a gelling agent, and about 10 ppm to 250 ppm of an alkoxylated alkyl phosphate ester surfactant.

The following Examples describe various embodiments of the present disclosure. Other embodiments within the scope of the appended claims will be apparent to a person of ordinary skill in the art considering the specification or practice of the disclosure provided herein. It is therefore intended that the specification, together with the Examples, be considered exemplary only, with the scope and spirit of the disclosure being indicated by the claims, which follow the Examples.

### Examples

In the Examples presented below, electrochemical cells of the present disclosure were tested for DSC performance, drop test amperage (both before and after the drop), partial discharge gassing and conditions after storage.

In the Examples presented below, gelled anodes and electrochemical cells were prepared in accordance with the improvements of the present disclosure. The electrochemical cells were tested for DSC performance, partial discharge cell gassing, undischarged cell gassing, and conditions after storage.

Gel viscosity was measured using Brookfield digital viscometer and Teflon-coated spindle #06 at 4 revolutions per minute (rpm). When measuring, allow the reading to stabilize over 5 min before recording the viscosity value.

As described above, for yield stress value measurement, measuring the gel viscosity values at 1.0 rpm (R1) and 0.5 rpm (R2) respectively, the yield stress value is calculated using the formula: yield stress value=(R2−R1)/100.

### Example 1—Undischarged Cell Gassing Performance

Gelled anodes were prepared using zinc alloy powder, KOH electrolyte and zinc loading of 63%, relative to the weight of the gel. The zinc powder had bismuth and indium as main alloying elements at a concentration of about 200 ppm and 200 ppm, respectively. The zinc anode had a particle size distribution containing high fine (HF) powder (i.e., smaller than 75 microns or 200 mesh size) at an optimum level of above 25 weight %. Two inhibitor compositions including, namely, Inhibitor A and Inhibitor B were tested in the gelled anodes to determine its impact on performance and reliability. Inhibitor A includes a phosphate-based anionic surfactant type sold commercially as Crodafos® T6A and is a polyethylene glycol ether of Tridecyl Alcohol. Inhibitor B includes a polyoxyethylene dinonylphenyl ether phosphate type, sold commercially as Rhodafac® RM-510 E.

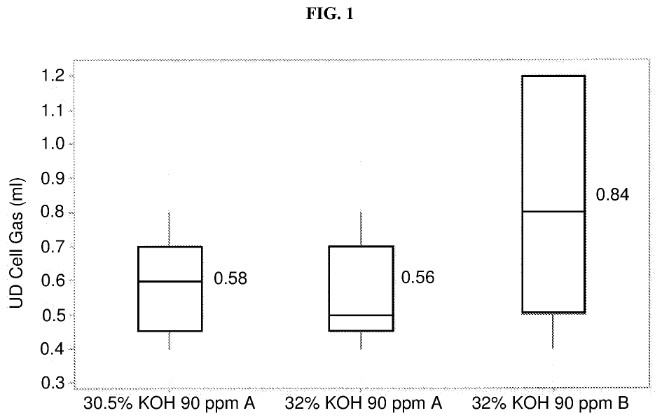

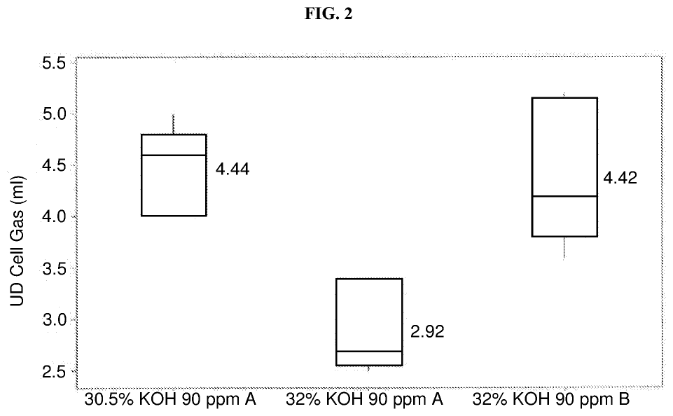

The undischarged cell characteristics were studied for cell containing the gelled anodes prepared as described above. FIG. 1 shows a comparison of the undischarged cell gassing of LR20 alkaline cells made with (i) 30.5% KOH with 90 ppm of inhibitor A, (ii) 32% KOH with 90 ppm of inhibitor A, and (iii) 32% KOH with 90 ppm of inhibitor B. Other cell anode components such as type of zinc, gelling agent, and zinc loading at 63% were kept the same for all the described cells. As is seen in FIG. 1, the average undischarged cell gassing with inhibitor A is lower than that with inhibitor B at 32% KOH. Gassing is generally expected to increase with decreasing KOH concentration. However, FIG. 2 shows that undischarged cell gassing at 30.5% KOH with inhibitor A is at least equal to that of cells made with inhibitor B at 32% KOH.

### Example 2—Partially Discharged Cell Gassing Performance

Cells prepared in accordance with the specifications of Example 1 were tested for partial discharge gassing. Cell gassing after partial discharge is anticipated to increase relative to undischarged cell gassing due to the breakdown of the passivating oxide film on the zinc anode surface caused by the discharge process. The inhibitor likely plays a key role in suppressing partial discharge. FIG. 2 shows the partial discharge cell gassing of LR20 cells of Example 1. It was observed that the partial discharge cell gassing decreases for inhibitor A relative to that with inhibitor B at 32% KOH. Further, even when the KOH concentration is reduced to 30.5%, partial discharge cell gassing with Inhibitor A remains the same as that of cells with inhibitor B at 32% KOH.

The inhibition differences on undischarged and on partially discharged cell gassing are attributed to distinct film characteristics formed by inhibitors A and B on the surface of the zinc anode.

### Example 3—Toy and Portable Stereo Test Performance

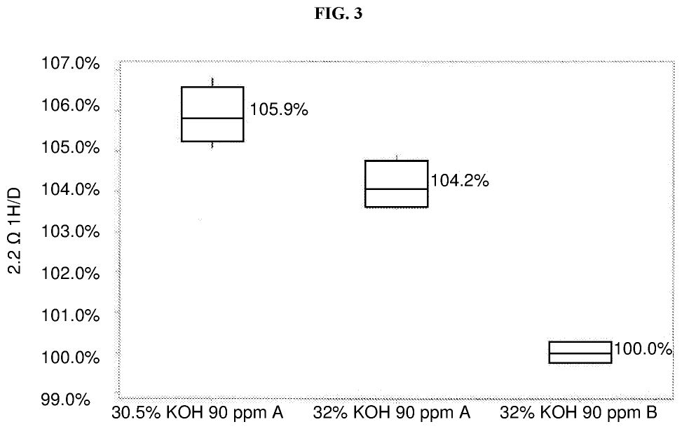

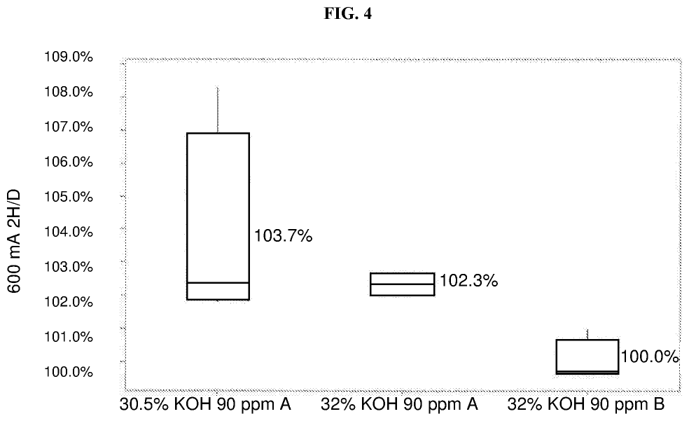

The LR20 batteries were discharged in a toy type test characterized by a discharge load of 2.2 ohms for one hour a day. FIG. 3 illustrates the effect on performance of LR20 batteries with varying KOH concentration and inhibitors A and B described in Example 1 when tested in a toy test. It was observed that the toy test performance improves with inhibitor A over that with inhibitor B at 32% KOH. Further performance enhancement is seen with inhibitor A at 30.5% KOH. As seen in FIG. 3, the average performance enhancement with inhibitor A in a toy test is about 4% at 32% KOH and about 5.9% at 30.5% KOH. A similar discharge performance improvement was observed in the portable stereo test characterized by a discharge load of 600 mA for two hours a day (FIG. 4). As is seen in FIG. 4, the performance enhancement with inhibitor A in the portable stereo test is about 2.3% at 32% KOH and 3.7% at 30.5% KOH.

### Example 4—Effect of Inhibitor on Cell Reliability

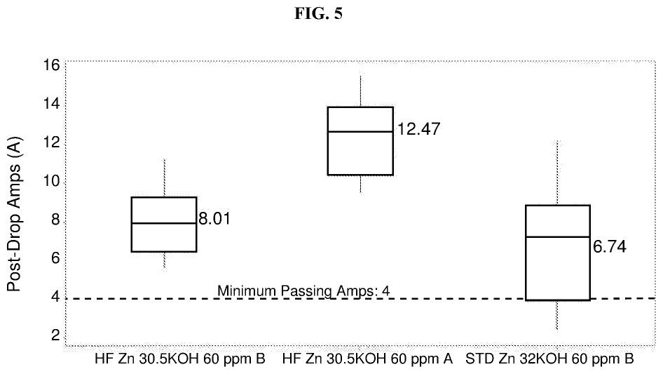

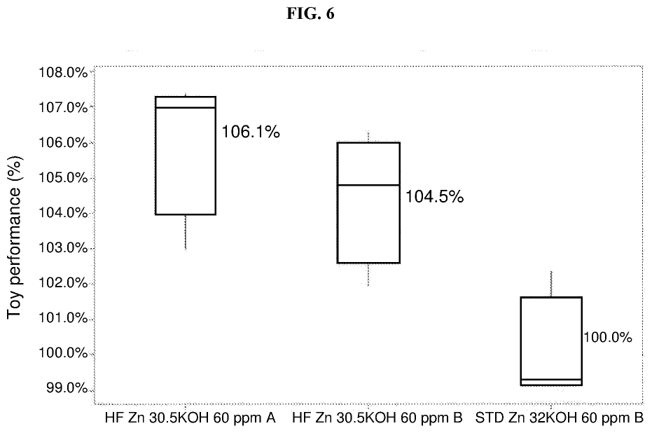

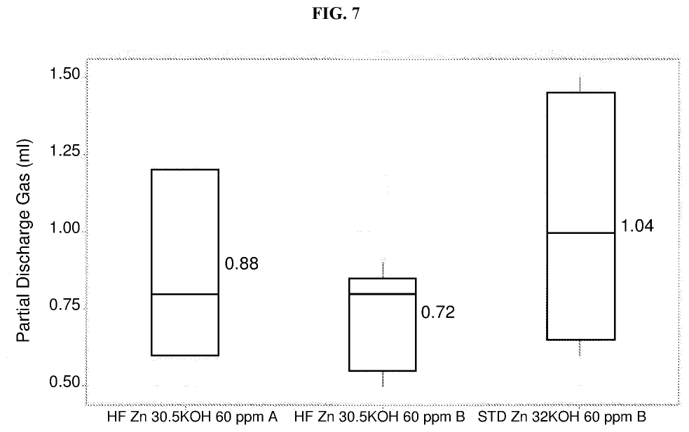

The Inhibitor type can also impact the abuse drop test results. As shown in FIG. 5, conventional LR20 cells made with standard zinc containing 10% of zinc fine particles at 32% KOH and 60 ppm of RM510 fail the drop test requiring minimum amperage of 4A to pass this test. In contrast, LR20 cells made with HF type zinc at 30.5% KOH and containing 60 ppm of inhibitor B pass this test. Further improvement in post-drop amps is seen with LR20 cells made with HF type zinc at 30.5% KOH and containing 60 ppm of inhibitor A. The corresponding toy discharge performance is seen in FIG. 6, and the respective partial discharge cell gassing is displayed in FIG. 7. Performance and cell gassing with inhibitors A and B are comparable at 30.5% KOH and 60 ppm of inhibitor concentration.

### Example 5—Effect of Apparent Density on Cell Performance

Gelled anodes were prepared using zinc alloy powder, KOH electrolyte and zinc loading of 66%, relative to the weight of the gel. The zinc powder had bismuth and indium as main alloying elements at a concentration of about 200 ppm and 200 ppm, respectively. The zinc anode had a particle size distribution containing high fine (HF) powder (i.e., smaller than 75 microns or 200 mesh size) at an optimum level of above 28% HF. The gel KOH concentration was tested at 30.5%. Various inhibitor surfactants including Novec® 4434, Rhodafac® RM510, and Crodafos® T6A were tested at concentrations of 100, 60, and 90 ppm, respectively. Zinc powders having the apparent density of zinc from about 2.80 g/cc to 3.15 g/cc were tested in the gelled anodes to determine its impact on gassing and cell performance.

### Example 6—LR20 Cells

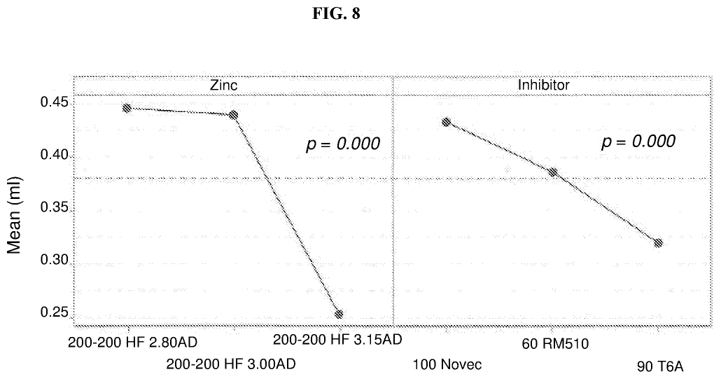

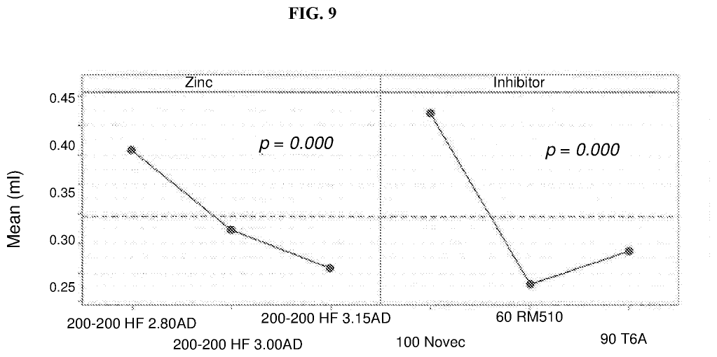

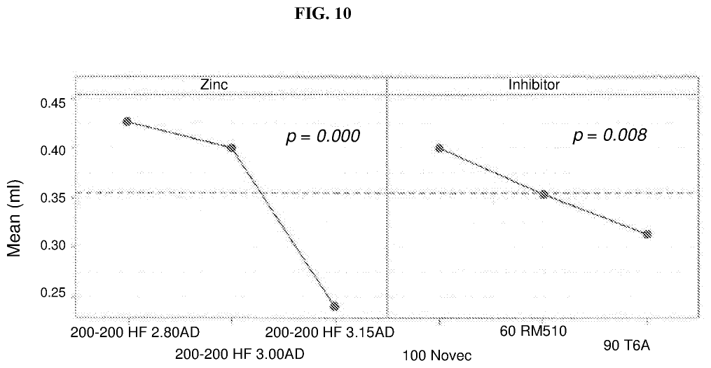

FIG. 8 and FIG. 9 display undischarged and partially discharged cell gassing, respectively, of LR20 cells, after storage for one week at 71° C. (160° F.), exhibiting the impact of increasing apparent density of zinc in the cells. The data in FIG. 8 and FIG. 9 indicates that the higher the apparent density, the lower the cell gassing, irrespective of the type of inhibitor surfactant used to suppress cell gassing. FIG. 10 shows suppressed gassing with increasing zinc apparent density for the undischarged LR20 cell after storage for two days at 85° C. (185° F.).

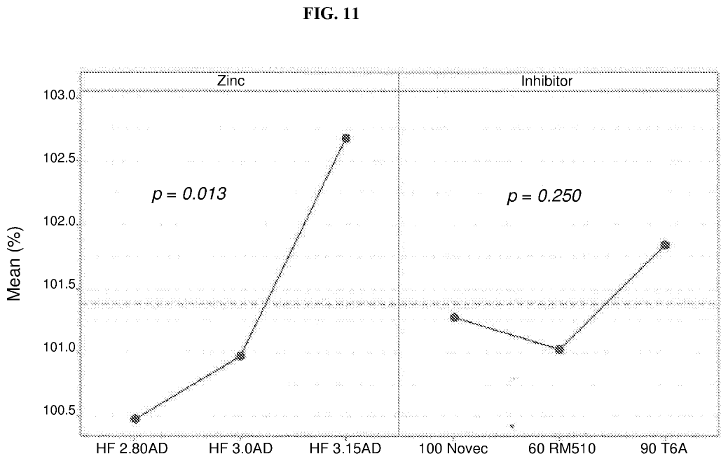

Electrochemical cells may be tested in accordance with methods under the American National Standards Institute (ANSI). These tests include determining cell performance/longevity under various discharge modes including cell pulse discharge, intermittent cell discharge, or Digital Still Camera, DSC (i.e., repeated application of 1500 mW (miliwatt) for a period of 2 seconds and 650 mW for a period of 28 seconds during a period of 5 mins every hour until the cell voltage reaches the end point voltage of 1.05 V), among other tests. Tests also include determining cell performance/longevity by discharging them in various devices such as Toys, Portable Stereo, Digital Audio, and Heavy Industrial Flashlight (HIFT). The LR20 batteries were discharged on the ASTM heavy industrial flashlight test (HIFT), which is 1.5 ohm, 4 min out of 15 min, 8 hr/day, and in a portable stereo type test which was 600 mA, 2 hours/day. The average discharge performance of LR20 batteries in HIFT and portable stereo tests is shown in FIG. 11. Enhanced discharge performance is seen with increasing apparent density.

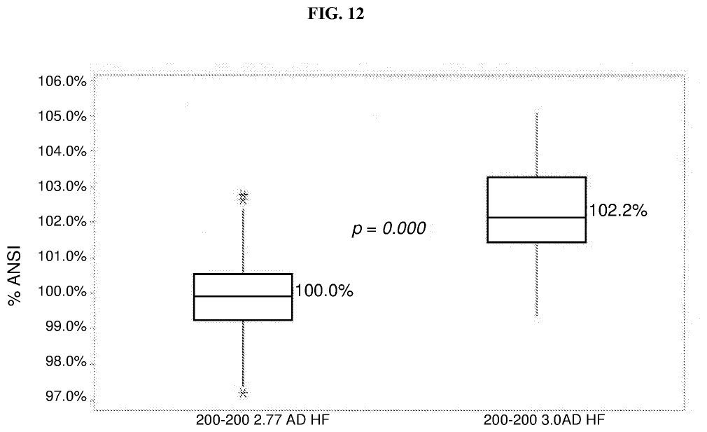

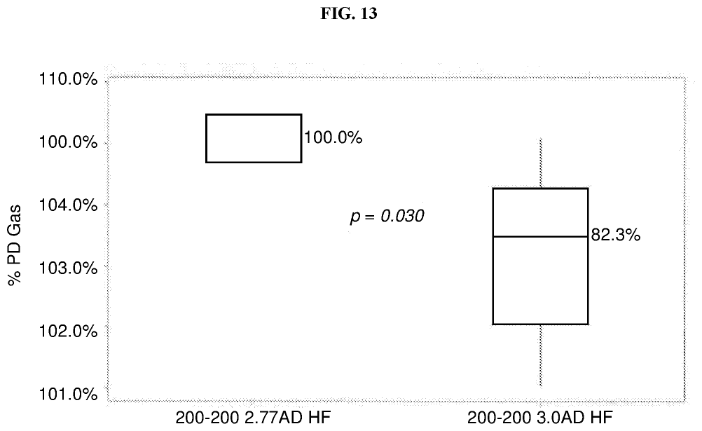

FIG. 12 illustrates the effect on performance of LR20 cells including gelled anodes with HF zinc at 63% loading, having apparent densities of 2.77 g/cc and 3.00 g/cc when tested in HIFT (1.5 ohm 4 min/15 hour (hr) 8 hr/day), portable stereo (600 mA for 2 hr/day), toy (2.2 ohm H/D), radio (10 ohm 4H/D), and Light Industrial Flashlight (LIFT) (2.2 ohm 4m/hr 8h/day) tests. The corresponding partial discharge cell gassing shown in FIG. 13 exhibits decreased gassing in cells with apparent density at about 3.0 g/cc. The anode gels of the LR20 cells described in FIG. 12 and FIG. 13 had a zinc loading of 63%, relative to the weight of the gel. The zinc powder had bismuth and indium as main alloying elements at a concentration of about 200 ppm and 200 ppm, respectively. The gel KOH concentration was tested at 30.5%. The Rhodafac® RM-510 concentration was tested at 60 ppm with zinc of apparent density at 3.0 g/cc and at 90 ppm for reference cell with zinc of apparent density at 2.77 g/cc.

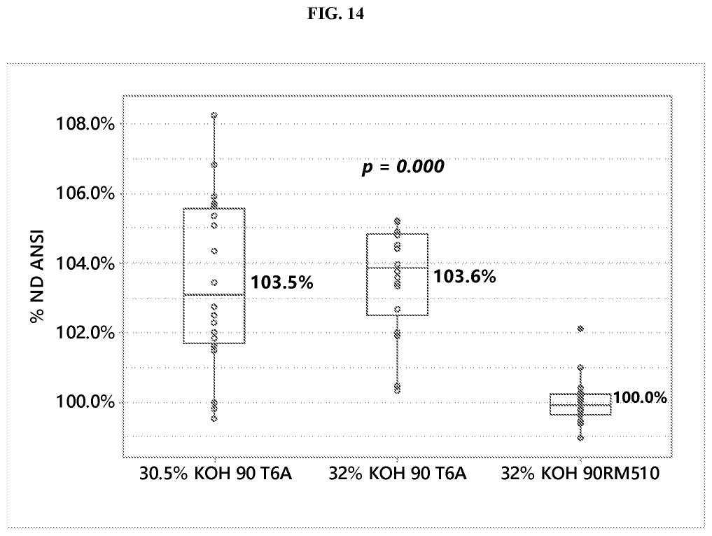

FIG. 14 illustrate the effect on ANSI performance tests of LR20 cells including gelled anodes with HF zinc at 63% loading having apparent density of 2.77 g/cc. The average performance from HIFT, portable stereo, toy, radio and LIFT tests, described above, are shown. The zinc powder whose data is shown in FIG. 14 had bismuth and indium as main alloying elements at a concentration of about 200 ppm and 200 ppm, respectively. The data in this figure applies to 90 ppm of Crodafos T6A and 90 ppm of Rhodafac RM510 with 30.5% KOH and 32% KOH, as well as to 90 ppm Crodafos T6A with 32% KOH.

### Example 7—LR14 Cells

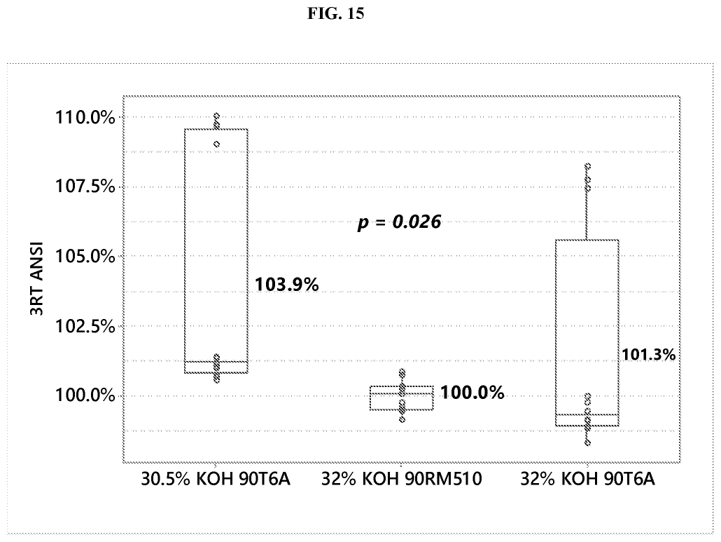

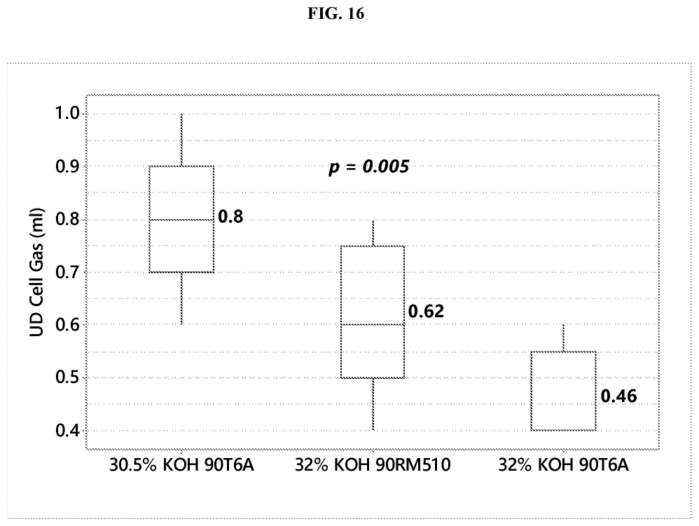

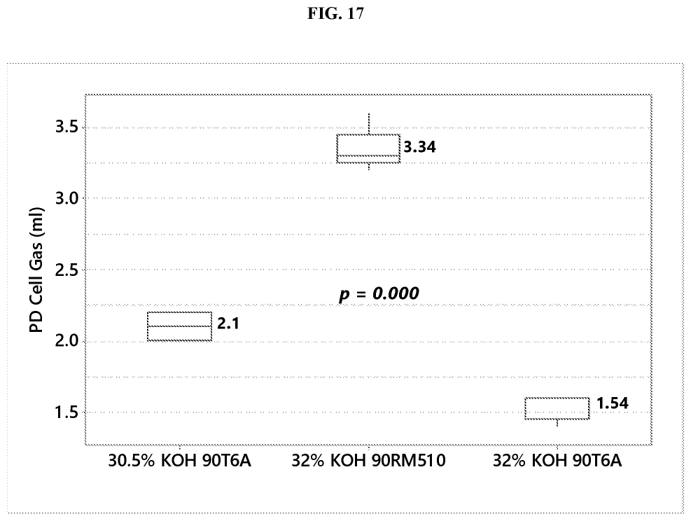

LR14 alkaline cells were made according to the procedure described in Example 5, with HF zinc at 63% loading having apparent density of 2.77 g/cc. FIG. 15 illustrates the effect on ANSI performance tests after three months of storage of the LR14 cells. FIG. 15 provides the average performance from portable stereo (400 mA 2 h/day to 0.9V), portable lighting (3.9Ω 4 min/h, 8 h/day to 0.9V), and toy test (3.9 o 1 h/day to 0.8 V). FIG. 16 and FIG. 17 show the corresponding undischarged cell gassing and partially discharged cell gassing, respectively, of the cells described in FIG. 15. The optimum LR14 performance results at 30.5% KOH shown in FIG. 15 are not compromised by reliability data, as shown with the corresponding undischarged and partially discharge cell gassing data shown in FIGS. 16 and 17, respectively.

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations may be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology may include, but is not limited to, the features and combinations of features recited in the following lettered paragraphs, it being understood that the following paragraphs should not be interpreted as limiting the scope of the claims as appended hereto or mandating that all such features must necessarily be included in such claims:
A. An alkaline electrochemical cell comprising:
   a cathode;
   a gelled anode comprising an anode active material, an alkaline electrolyte, a gelling agent, and about 10 ppm to 250 ppm of an alkoxylated alkyl phosphate ester surfactant; and
   a separator disposed between the cathode and the anode;
   wherein:
      the anode active material has an apparent density from about 2.60 g/cc to about 3.35 g/cc;
      about 15% to about 60% by weight of the anode active material relative to a total amount of anode active material has a particle size of less than about 75 μm; and
      about 5% to about 25% by weight of the anode active material relative to the total amount of the anode active material has a particle size of greater than about 150 μm.
B. The alkaline electrochemical cell of Paragraph A, wherein the alkoxylated alkyl phosphate ester surfactant comprises polyoxyethylene tridecyl ether phosphate.
C. The alkaline electrochemical cell of Paragraph A or Paragraph B, wherein the electrolyte has a hydroxide concentration of about 24 wt % to about 36 wt %.
D. The alkaline electrochemical cell of any one of Paragraphs A-C, wherein the gelled anode comprises about 0.4% to about 1.0% by weight of the gelling agent.
E. The alkaline electrochemical cell of any one of Paragraphs A-D, wherein the gelling agent comprises a crosslinked polyacrylic acid.
F. The alkaline electrochemical cell of any one of Paragraphs A-E, wherein the anode active material comprises a zinc alloy.
G. The alkaline electrochemical cell of Paragraph F, wherein the zinc alloy comprises zinc, indium, and bismuth.
H. The alkaline electrochemical cell of Paragraph F or Paragraph G, wherein the zinc alloy comprises about 130 ppm to about 270 ppm of bismuth
I. The alkaline electrochemical cell of any one of Paragraphs F-H, wherein the zinc alloy comprises about 130 ppm to about 270 ppm of indium.
J. The alkaline electrochemical cell of any one of Paragraphs wherein the zinc alloy is present in the anode from about 62% to about 72% by weight relative to the total weight of the anode.
K. The alkaline electrochemical cell of any one of Paragraphs F-J, wherein less than 10% by weight of the anode active material relative to the total amount of anode active material has a particle size of less than about 45 microns.
L. The alkaline electrochemical cell of any one of Paragraphs F-K, wherein about 20% to about 50% by weight relative to a total weight of anode active material has a particle size of less than about 75 μm.
M. The alkaline electrochemical cell of any one of Paragraphs F-L, the alkaline electrolyte comprises about 26% % to about 36% by weight of potassium hydroxide;
N. The alkaline electrochemical cell of any one of Paragraphs F-M, the alkoxylated alkyl phosphate ester surfactant comprises polyoxyethylene tridecyl ether phosphate; and
O. The alkaline electrochemical cell of any one of Paragraphs F-N which is a LR14 or a LR20 cell.
P. A gelled anode for an alkaline electrochemical cell, the gelled anode comprising:
   an anode active material with an apparent density from about 2.60 g/cc to about 3.35 g/cc, wherein from about 15% to about 60% by weight relative to a total weight of anode active material has a particle size of less than about 75 μm, and about 5% to about 25% by weight of the anode active material relative to the total amount of the anode active material has a particle size of greater than about 150 μm;
   an alkaline electrolyte;
   a gelling agent; and
   about 10 ppm to 250 ppm of an alkoxylated alkyl phosphate ester surfactant.
Q. The gelled anode of Paragraph P, wherein the alkoxylated alkyl phosphate ester surfactant comprises polyoxyethylene tridecyl ether phosphate.
R. The gelled anode of Paragraph P or Paragraph Q, wherein the alkaline electrolyte comprises a hydroxide concentration of about 24% to about 36%.
S. The gelled anode of any one of Paragraphs P-R, comprising from about 0.4% to about 1.0% by weight of the gelling agent.
T. The gelled anode of any one of Paragraphs P-S, wherein the gelling agent comprises a crosslinked polyacrylic acid.
U. The gelled anode of any one of Paragraphs P-T, wherein the anode active material comprises a zinc alloy.
V The gelled anode of Paragraph U, wherein the zinc alloy comprises zinc, indium and bismuth.
W. The gelled anode of Paragraph U or Paragraph V, wherein the zinc alloy comprises about 130 ppm to about 270 ppm of bismuth.
X. The gelled anode of any one of Paragraphs U-W, wherein the zinc alloy comprises about 130 ppm to about 270 ppm of indium.
Y The gelled anode of any one of Paragraphs U-X, wherein the zinc alloy is present in the anode from about 62% to about 72% by weight relative to the total weight of the anode.
Z. The gelled anode of any one of Paragraphs P-Y, wherein less than 10% by weight of the anode active material relative to the total amount of anode active material has a particle size of less than about 45 microns.
AA. The gelled anode of any one of Paragraphs P-Z, wherein about 20% to about 50% by weight relative to a total weight of anode active material has a particle size of less than about 75
AB. The gelled anode of any one of Paragraphs P-AA, the alkaline electrolyte comprises about 26% % to about 36% by weight of potassium hydroxide;
AC. The gelled anode of any one of Paragraphs P-AB, the alkoxylated alkyl phosphate ester surfactant comprises polyoxyethylene tridecyl ether phosphate; and

Other embodiments are set forth in the following claims.

What is claimed is:

1. An alkaline electrochemical cell comprising:
a cathode;
a gelled anode comprising an anode active material, an alkaline electrolyte, a gelling agent, and about 10 ppm to 250 ppm of an alkoxylated alkyl phosphate ester surfactant; and
a separator disposed between the cathode and the anode;
wherein:
the anode active material has an apparent density from about 2.60 g/cc to about 3.35 g/cc;
about 15% to about 60% by weight of the anode active material relative to a total amount of anode active material has a particle size of less than about 75 μm; and
about 5% to about 25% by weight of the anode active material relative to the total amount of the anode active material has a particle size of greater than about 150 μm.

2. The alkaline electrochemical cell of claim 1, wherein the alkoxylated alkyl phosphate ester surfactant comprises polyoxyethylene tridecyl ether phosphate.

3. The alkaline electrochemical cell of claim 1, wherein the alkaline electrolyte has a hydroxide concentration of about 24 wt % to about 36 wt %.

4. The alkaline electrochemical cell of claim 1, wherein the gelled anode comprises about 0.4% to about 1.0% by weight of the gelling agent.

5. The alkaline electrochemical cell of claim 1, wherein the gelling agent comprises a crosslinked polyacrylic acid.

6. The alkaline electrochemical cell of any one of claims 1-5, wherein the anode active material comprises a zinc alloy.

7. The alkaline electrochemical cell of claim 6, wherein the zinc alloy comprises zinc, indium, and bismuth.

8. The alkaline electrochemical cell of claim 6, wherein the zinc alloy comprises about 130 ppm to about 270 ppm of bismuth

9. The alkaline electrochemical cell of claim 6, wherein the zinc alloy comprises about 130 ppm to about 270 ppm of indium.

10. The alkaline electrochemical cell of claim 6, wherein the zinc alloy is present in the anode from about 62% to about 72% by weight relative to the total weight of the anode.

11. The alkaline electrochemical cell of claim 1 which is a LR14 or a LR20 cell.

12. A gelled anode for an alkaline electrochemical cell, the gelled anode comprising:
an anode active material with an apparent density from about 2.60 g/cc to about 3.35 g/cc, wherein from about 15% to about 60% by weight relative to a total weight of anode active material has a particle size of less than about 75 μm, and about 5% to about 25% by weight of the anode active material relative to the total amount of the anode active material has a particle size of greater than about 150 μm;
an alkaline electrolyte;
a gelling agent; and
about 10 ppm to 250 ppm of an alkoxylated alkyl phosphate ester surfactant.

13. The gelled anode of claim 12, wherein the alkoxylated alkyl phosphate ester surfactant comprises polyoxyethylene tridecyl ether phosphate.

14. The gelled anode of claim 12, wherein the electrolyte has a hydroxide concentration of about 24% to about 36%.

15. The gelled anode of claim 12, comprising from about 0.4% to about 1.0% by weight of the gelling agent.

16. The gelled anode of claim 12, wherein the gelling agent comprises a crosslinked polyacrylic acid.

17. The gelled anode of any one of claims 12-16, wherein the anode active material comprises a zinc alloy.

18. The gelled anode of claim 17, wherein the zinc alloy comprises zinc, indium and bismuth.

19. The gelled anode of claim 17, wherein the zinc alloy comprises about 130 ppm to about 270 ppm of bismuth.

20. The gelled anode of claim 17, wherein the zinc alloy comprises about 130 ppm to about 270 ppm of indium.

21. The gelled anode of claim 12, wherein the anode active material comprises a zinc alloy and the amount of zinc alloy is in the anode is present from about 62% to about 72% by weight relative to a total weight of the anode.

22. The gelled anode of claim 12, wherein less than 10% by weight of the anode active material relative to the total amount of anode active material has a particle size of less than about 45 microns.

23. The gelled anode of claim 12, wherein:
about 20% to about 50% by weight relative to a total weight of anode active material has a particle size of less than about 75 μm;
the alkaline electrolyte comprises about 26% % to about 36% by weight of potassium hydroxide;
the alkoxylated alkyl phosphate ester surfactant comprises polyoxyethylene tridecyl ether phosphate; and
the gelled anode comprises about 0.4% to about 1.0% by weight of the gelling agent.
